(19) United States
(12) Patent Application Publication
(10) Pub. No.: US 2025/0066642 A1
(43) Pub. Date: Feb. 27, 2025

(54) Pressure-sensitive adhesive compound and redetachable self-adhesive products comprising the pressure-sensitive adhesive compound

(71) Applicant: TESA SE, Norderstedt (DE)

(72) Inventors: Thilo DOLLASE, Hamburg (DE); Julia GARBERS, Hamburg (DE)

(21) Appl. No.: 18/812,453

(22) Filed: Aug. 22, 2024

(30) Foreign Application Priority Data
Aug. 24, 2023 (DE) 102023122769.6

(51) Int. Cl. C09J 7/38; C09J 7/24; C09J 7/25; C09J 11/08

(52) U.S. Cl. CPC C09J 7/387; C09J 7/241; C09J 7/25; C09J 11/08; C09J 2203/37; C09J 2301/124; C09J 2301/302; C09J 2301/408; C09J 2301/414

(57) ABSTRACT

Pressure-sensitive adhesive compound containing:
a) at least 28% by weight and at most 60% by weight of an elastomer component, wherein
i. the elastomer component contains at least 60% by weight and preferably at most 90% by weight, based in each case on the elastomer component, of at least one hydrogenated polyvinylaromatic-polydiene block copolymer having a polyvinylaromatic fraction of at least 18% by weight and a peak molecular weight of 100,000 to 500,000 g/mol, determined according to GPC (Test i),
ii. the polydiene blocks are substantially fully hydrogenated,
iii. the hydrogenated polyvinylaromatic-polydiene block copolymer has an ABA structure, (AB)ₙZ structure with n=2 or radial (AB)ₙ structure or radial (AB)ₙ−Z structure with n≥3, wherein A=polyvinylaromatic, B=ethylene and butylene or ethylene and propylene and Z=derivative of a coupling substance, and wherein the ethylene fraction in the B blocks is preferably at least 50% by weight, and
iv. the elastomer component contains at least one kind of a hydrogenated diblock copolymer having an A′B′ structure or (A′B′)ₙZ structure with n=1, wherein A′=polyvinylaromatic, B′=ethylene and butylene or ethylene and propylene, Z=derivative of a coupling substance, and possibly A′=A and B′=B,
b) a tackifier resin component,
c) optionally a plasticizer component,
d) at least 2.5% by weight to 22% by weight, preferably at least 4% by weight to 18% by weight, of a reinforcing component which is at least one resin having an MMAP value between −10° C. and +30° C., preferably between 0° C. and +20° C., and a softening point of at least 140° C.,
e) optionally further adjuvants,
the fraction of the elastomer component being based on the total weight of the pressure-sensitive adhesive compound.

The present invention relates to a pressure-sensitive adhesive compound and to self-adhesive products, more particularly double-sidedly adhesive self-adhesive products, which are redetachable from an adhesive bond by extensive stretching and comprise the pressure-sensitive adhesive compound.

Adhesives and adhesive tapes are used in general to assemble two substrates in such a way as to form a lasting or permanent bond. Last but not least, trends are evident that such permanent bonds should be separated again for recycling purposes. Accordingly, adhesive solutions are sought that initially offer application-oriented bonding properties, but are also redetachable. One of the challenges here is to realize bonding performance in line with increasingly demanding applications, for example with regard to the materials to be bonded, but also in terms of the resistance of the bond. For example, high thermal shear strengths are required for automotive bonds, including those to mounted plastic components. A common material for such mounted components is PP/EPDM, PP/EPM or PP/EPR. Bonding such materials poses a particular challenge.

Self-adhesive products that are redetachable by extensive stretching and contain one or more layers based on styrene block copolymers are known.

From DE 100 03 318 A1, DE 102 52 088 A1, DE 102 52 089 A1 and DE 10 2007 021 504 A1, approaches are known to propose formulations, based on hydrogenated polystyrene-polydiene block copolymers, that are suitable for self-adhesive products that are redetachable by extensive stretching.

Furthermore, it is known practice to use so-called endblock reinforcers in formulations with hydrogenated polystyrene-polydiene block copolymers.

EP 0 302 394 A2 teaches formulations containing SEBS triblock and/or diblock (preferably 20-40%) with hydrogenated aromatic resin and optionally an endblock reinforcer (“non-hydrogenated pure monomer endblock reinforcing resin”). The disclosed compositions which actually contain endblock reinforcers have an elastomer fraction of only about 25%.

EP 1 700 895 A1 discloses formulations containing SEPS and/or SEEPS and tackifier resins as well as optionally additionally aromatic resins which have an elastomer content of 1% to 10% by weight.

EP 3 650 500 A1 and EP 3 798 262 A1 describe formulations with hydrogenated SBCs and a maximum elastomer content of around 12% by weight.

However, there is still a need to develop robust adhesives and corresponding products comprising these adhesives that have an excellent property profile for the respective requirement even after storage under hot and humid conditions.

The object of the present invention was therefore to provide a pressure-sensitive adhesive compound and a self-adhesive product which is redetachable by extensive stretching, comprising the pressure-sensitive adhesive compound, which is characterized by improved detachment characteristics after hot and humid storage of a corresponding bonded assembly comprising the pressure-sensitive adhesive compound or the self-adhesive product. At the same time, a high long-term stability is to be ensured. In addition, the pressure-sensitive adhesive compound or the self-adhesive product should have a good bonding performance, especially on polar substrates, such as steel, and possibly also on non-polar substrates, such as PP/EPDM, PP/EPM or PP/EPR, despite its detachability. Furthermore, the pressure-sensitive adhesive compound or the self-adhesive product should have an optimal thermal shear strength.

This object is achieved in an unexpected manner by the pressure-sensitive adhesive compound as described in Claim 1 and by the self-adhesive product as described in Claim 13. Subjects of the dependent claims are advantageous developments of the subject-matter of the invention. Furthermore, an adhesively bonded assembly is part of the invention. Further advantageous configurations of the invention result from the description as set out below.

Such and further embodiments which are hereinafter designated as preferred are combined in more preferred embodiments with features of other embodiments designated as preferred. Especially preferred are therefore combinations of two or more of the embodiments described below as more preferred. Also preferred are embodiments in which a feature of one embodiment which is designated in any degree as preferred is combined with one or more further features of other embodiments which are designated in any degree as preferred.

Features of preferred self-adhesive products and also uses result from the features of preferred pressure-sensitive adhesive compounds.

A first subject of the present invention is a pressure-sensitive adhesive compound containing:
a) at least 28% by weight and at most 60% by weight of an elastomer component, wherein
   i. the elastomer component contains at least 60% by weight and preferably at most 90% by weight, based in each case on the elastomer component, of at least one hydrogenated polyvinylaromatic-polydiene block copolymer having a polyvinylaromatic fraction of at least 18% by weight and a peak molecular weight of 100,000 to 500,000 g/mol, determined according to GPC (Test 1),
   ii. the polydiene blocks are substantially fully hydrogenated,
   iii. the hydrogenated polyvinylaromatic-polydiene block copolymer has an ABA structure, (AB)ₙZ structure with n=2 or radial (AB)ₙ structure or radial (AB)ₙ−Z structure with n≥3, wherein A=polyvinylaromatic, B=ethylene and butylene or ethylene and propylene and Z=derivative of a coupling substance, and wherein the ethylene fraction in the B blocks is preferably at least 50% by weight, and
   iv. the elastomer component contains at least one kind of a hydrogenated diblock copolymer having an A′B′ structure or (A′B′)ₙZ structure with n=1, wherein A′=polyvinylaromatic, B′=ethylene and butylene or ethylene and propylene, Z=derivative of a coupling substance, and possibly A′=A and B′=B,
b) a tackifier resin component,
c) optionally a plasticizer component,
d) at least 2.5% by weight to 22% by weight, preferably at least 4% by weight to 18% by weight, of a reinforcing component which is at least one resin having an MMAP value between −10° C. and +30° C., preferably between 0° C. and +20° C., and a softening point of at least 140° C.,
e) optionally further adjuvants, the fraction of the elastomer component being based on the total weight of the pressure-sensitive adhesive compound.

In the context of the present invention, “substantially fully hydrogenated” means a degree of hydrogenation of at least 90%, preferably at least 95% and particularly preferably at least 99%. Hydrogenated block copolymers are understood within the scope of the present invention to mean those in which the polydiene blocks are substantially fully hydrogenated.

Examples of coupling substances that can be used according to the invention can be found in publications including Holden (G. Holden, D. R. Hansen in “Thermoplastic Elastomers”, G. Holden, H. R. Kricheldorf, R. P. Quirk (Eds.), 3rd Ed. 2004, C. Hanser, Munich, p. 49f), without wanting thereby to impose any limitation.

In line with the general understanding, a pressure-sensitive adhesive compound is understood to be an adhesive compound that allows a durable connection to almost all adhesion substrates even under relatively low contact pressure and, if necessary, after use, can be detached again from the adhesion substrate substantially without residue. A pressure-sensitive adhesive compound has permanent pressure-sensitive adhesion at room temperature, i.e. has a sufficiently low viscosity and high tackiness to the touch, such that it wets the surface of the respective substrate even at low contact pressure. The bondability of the adhesive compound is based on its adhesive properties, and the redetachability on its cohesive properties.

In the context of the present invention, the term “hot and humid conditions” refers in particular to conditions comprising a relative humidity of more than 60% and an ambient temperature of more than 25° C.

In the context of the present invention, a temperature of 85° C. and a relative humidity of 85% are used for the tests as a standardized ambient climate.

“Storage under hot and humid conditions” means, in particular, that the materials or articles considered are stored for a period of more than one day at a relative humidity of more than 60% and an ambient temperature of more than 25° C. Long storage times, such as in particular more than 100 hours, for example 500 or 1,000 hours, are particularly significant in this context.

### Pressure-Sensitive Adhesive Compound

The pressure-sensitive adhesive compound of the invention preferably meets the performance requirement specified in the following table.

TABLE 1
Preferred performance profile

| | Measurement | | | |
|---|---|---|---|---|
| Requirement | method | typical | preferred | very preferred |
| Peel adhesion, steel | Test II | ≥10.0 N/cm | ≥15.0 N/cm | ≥20.0 N/cm |
| (500 μm single- | | | | |
| layer product) | | | | |
| Detachment test | Test III | ≤25% | ≤15% | ≤10% |
| Tear rate 85° C. | | | | |
| Detachment test | Test III | ≤25% | ≤15% | ≤10% |
| Tear rate | | | | |
| 85° C./85% rel. h. | | | | |

“Tear rate 85° C.” or “Tear rate 85° C./85% rel. h.” (rel. h.=relative humidity) refers to the tear rate after storing the samples for 7 days each under the specified conditions, i.e. at elevated temperature or under hot/humid conditions (see Test methods).

In the context of the present invention, it has emerged above all that the advantageous combination of properties, in particular a high peel adhesion and optimized detachment characteristics even after storage under hot and humid conditions, can be achieved by a balanced coordination of the individual components of the pressure-sensitive adhesive compound, but not by those which have been disclosed in many cases in the prior art.

### a) Elastomer Component

Thus, formulations according to the invention which are suitable are those which contain at least 28% by weight and at most 60% by weight, preferably between 35% by weight and 58% by weight, very preferably between 40% by weight and 52% by weight of an elastomer component, wherein the elastomer component contains at least 60% by weight, preferably at least 70% by weight and very preferably at least 80% by weight, and preferably at most 90% by weight, based on the elastomer component, of at least one hydrogenated polyvinylaromatic-polydiene block copolymer.

The at least one hydrogenated polyvinylaromatic-polydiene block copolymer which is used according to the invention is characterized by a linear ABA structure or linear (AB)ₙZ structure with n=2 or radial (AB)ₙ structure or radial (AB)ₙZ structure with n≥3. Vinylaromatics for formation of the A block preferably include styrene, α-methylstyrene and/or other styrene derivatives. The A block may thus be in the form of a homo- or copolymer. More preferably, the A block is a polystyrene. Block copolymers of this type form the backbone of the formulation. They form an essential part, via which influence is exerted on the adhesive properties and also the tear resistance and thus the detachment characteristics. However, too high a fraction or an unfavourable choice of the molar mass of block copolymers of this type can reduce the peel adhesion. In order to balance out these properties optimally, it has emerged that block copolymers of this type should have a peak molecular weight of at least about 100,000 g/mol and at most about 500,000 g/mol. The higher the molecular weight, the more challenging the processability of the material. Therefore, a peak molecular weight of no more than 250,000 g/mol is preferred. Very advantageous are linear triblock copolymers or radial block copolymers with a peak molecular weight between 100,000 g/mol and 200,000 g/mol, in particular between 100,000 g/mol and 180,000 g/mol.

In order to achieve a property profile that meets the requirements, a minimum of 18% by weight of polyvinylaromatic fraction is selected in the at least one block copolymer of this type. However, this fraction should not be too high either, as the peel adhesion is reduced if the fraction is too high. It is advantageous if the polyvinylaromatic fraction is not higher than 35% by weight. A polyvinylaromatic fraction in a range between 20% by weight and 33% by weight is favourable. The fraction of polyvinylaromatics in the hydrogenated polyvinylaromatic-polydiene block copolymers can be determined, for example, by means of ¹H- or ¹³C-NMR (nuclear magnetic resonance spectroscopy, Test IX). For commercially available hydrogenated polyvinylaromatic-polydiene block copolymers, the fraction of polyvinylaromatics can also be found in the manufacturer's specifications.

The hydrogenated polyvinylaromatic-polydiene block copolymers used in the pressure-sensitive adhesive compound of the invention are preferably those obtained by anionic polymerization and sequential addition of the monomers for the respective polymer blocks, vinylaromatics for the A blocks and dienes for the B blocks. In many production processes, diblock intermediates AB are coupled to triblock copolymers (2 AB+Z′→AB−Z−BA) or radial copolymers using a coupling agent Z′. Subsequently, the B blocks are selectively hydrogenated, so that preferably ethylene and butylene or ethylene and propylene result as B blocks.

Preferably, block copolymers that are substantially fully hydrogenated with respect to the polydiene blocks (B blocks) are used. The ethylene fraction in the B blocks is preferably at least 50% by weight.

According to preferred embodiments of the invention, the elastomer component contained in the pressure-sensitive adhesive compound is not sulfonated in the vinylaromatic blocks.

In order further to improve the property profile of the pressure-sensitive adhesive compound according to the invention, it has proven to be advantageous if the elastomer component contains up to 35% by weight, based on the elastomer component, of the at least one kind of the hydrogenated diblock copolymer.

The polymer blocks defined and contained in accordance with iii. and iv. may differ, for example, in terms of molar mass and/or composition.

Preferably, the fraction of the hydrogenated diblock copolymer in the elastomer component is not more than 35% by weight, preferably 10% to 30% by weight, based in each case on the total weight of the elastomer component.

Hydrogenated diblock copolymers can be used advantageously to influence the peel adhesion and the flow-on characteristics.

In one preferred embodiment, the at least one diblock copolymer has a peak molecular weight, determined via GPC, of <100,000 g/mol.

In a further-preferred embodiment, the at least one diblock copolymer has a peak molecular weight, determined via GPC, of greater than 100,000 g/mol.

According to preferred embodiments, the elastomer component also contains a further hydrogenated polyvinylaromatic-polydiene block copolymer, which is characterized by a linear ABA structure and linear (AB)ₙZ structure with n=2 or radial (AB)ₙ structure and also radial (AB)ₙZ structure with n≥3. This block copolymer may have a polyvinylaromatic fraction of less than 18% by weight or more and independently thereof a peak molecular weight of more than 500,000 g/mol or less than 100,000 g/mol or in between. It can also contain several of this type.

As a result, the pressure-sensitive adhesive compound exhibits improved processability.

### b) Tackifier Resin Component

The pressure-sensitive adhesive compound of the invention further contains a tackifier resin component.

The tackifier resin component is in particular one or more tackifier resins.

The tackifier resin component is not to be understood as a reinforcing component within the context of the present invention, i.e. the tackifier resin component is preferably substantially not compatible with the hard blocks of the polydiene block copolymers. The tackifier resin or resins are therefore selected in such a way that they are mainly miscible (compatible) with the areas of the pressure-sensitive adhesive compound dominated by the B blocks.

The tackifier resin component is used in particular to set the adhesion in a desired manner. According to the general understanding of the skilled person, a “tackifier resin” is understood to mean an oligomeric or polymeric resin that increases the adhesion, i.e. the intrinsic stickiness, of the pressure-sensitive adhesive compound in comparison to an otherwise identical pressure-sensitive adhesive compound nevertheless not containing any tackifier resin. Tackifier resins are specific compounds with low molar mass compared to elastomers, usually with a weight-average molecular weight M_{w} of less than 5,000 g/mol. Typically, the weight-average molecular weight of a tackifier resin component used in the context of the present invention is from 400 to 5,000 g/mol, preferably from 500 to 2,000 g/mol, determined by GPC (Test Ib).

The fraction of tackifier resin component in the pressure-sensitive adhesive compound has a positive effect on the bond strength. The tackifier resin fraction ought therefore not to be too low. However, it has been shown that too high a fraction of tackifier resin(s) has a negative effect on the thermal shear strength and, in particular, on the redetachability. The fraction of the tackifier resin component, based on the total weight of the pressure-sensitive adhesive compound, is preferably 28% by weight to 55% by weight, more preferably 35% by weight to 50% by weight.

At least one tackifier resin is further characterized in that it has a softening temperature by the ring and ball method of greater than 95° C., but not more than 135° C. The softening temperature can be determined according to Test IV as described below. Preferably, all tackifier resins in the tackifier resin component have a softening temperature in this range.

Preferably, the at least one tackifier resin of the tackifier resin component is selected from the group consisting of resins based on dicyclopentadiene, hydrocarbon resins based on C₅, C₅/C₉ or C₉ monomer streams, polyterpene resins based on α-pinene and/or β-pinene and δ-limonene and polymers of pure C₈ or C₉ aromatics, the resin being partially or, in particular, fully hydrogenated.

In the context of the present invention, “partially hydrogenated” means a degree of hydrogenation of at least 80%, preferably at least 85%.

The adhesive compound of the invention preferably has at least one tackifier resin in the tackifier resin component which has a DACP (diacetone alcohol cloud point) of at least 30° C., preferably of at least 40° C. The DACP is determined according to Test V as described below.

In a further preferred embodiment, the pressure-sensitive adhesive compound of the invention in the tackifier resin component comprises at least one tackifier resin having an MMAP (mixed methylcyclohexane aniline point) of greater than 60° C., preferably greater than 70° C. The MMAP is determined according to Test VI as described below.

In addition to the at least one above-described tackifier resin, the tackifier resin component may also contain one or more further tackifier resins that do not meet the specified definitions with regard to softening temperature and/or DACP and/or MMAP cloud point. Tackifier resins with a softening temperature below 95° C., such as about 90° C. or about 85° C., can also be used to a proportion of up to 10% by weight or even up to 20% by weight in relation to the composition of the tackifier resin component. For example, tackifier resins with a softening temperature above 135° C., such as about 140° C., can also be used to a proportion of up to 10% by weight or even up to 20% by weight in relation to the composition of the tackifier resin component.

Tackifier resins with an MMAP cloud point below 60° C. or even below 45° C. and/or a DACP cloud point below 30° C. or even below 15° C. can also be used with a proportion of up to 20% by weight or even up to 40% by weight in relation to the composition of the tackifier resin component. Examples of such tackifier resins are terpene-phenol resins, in particular having an OH number of not more than 100 mg KOH/g, and rosin esters, which may be partially hydrogenated, fully hydrogenated or disproportionated.

### c) Plasticizer Component

In addition to the elastomer component and the tackifier resin component, the pressure-sensitive adhesive compound of the invention may also contain a plasticizer component. The fraction of plasticizer component, based on the total weight of the pressure-sensitive adhesive compound, is preferably 2% to 25% by weight, particularly preferably 2% to 20% by weight, very preferably 4% to 15% by weight. Surprisingly, it has emerged that an already low proportion of plasticizer components in the quantities mentioned is sufficient to obtain a pressure-sensitive adhesive compound with a sufficiently high bond strength, which is in contrast to what the prior art teaches, where in some cases a content of plasticizers of 60% to 95% by weight is assumed.

The plasticizer component is one or more plasticizers.

The plasticizer is preferably selected from the group consisting of ethylene/propylene copolymer, ethylene/butylene copolymer, butylene/isobutylene (co)polymer, butylene homopolymer and isobutylene homopolymer, the amorphous representatives being preferred in each case.

In a further-preferred embodiment, the plasticizer has a weight-average molecular mass, determined by GPC (Test I), of at least 100,000 g/mol and at most 1,000,000 g/mol. In these cases, the plasticizer is preferably an ethylene/propylene copolymer or ethylene/butylene copolymer with a linear or radial structure. These copolymers contained as plasticizer component are not block copolymers containing hard blocks within the scope of the present invention.

In another particularly preferred embodiment, the plasticizer has a weight-average molar mass, determined by means of GPC (Test I), of at least 3,000 g/mol and at most 20,000 g/mol. In this case, the plasticizer is preferably a butylene/isobutylene (co)polymer. Plasticizer resins based on rosin, more particularly methyl esters of rosin or of partially or fully hydrogenated rosin, are also suitable.

### d) Reinforcing Component

The pressure-sensitive adhesive compound of the invention contains a reinforcing component.

The reinforcing component is not to be understood as a tackifier resin component within the scope of the present invention, i.e. the reinforcing component is preferably substantially not compatible with the soft blocks, i.e. the polydiene blocks.

In particular, so-called end block reinforcers are used as the reinforcing component according to the invention.

End block reinforcers are those materials that are substantially compatible with the hard blocks of the polydiene block copolymers.

The at least one resin of the reinforcing component is preferably at least one resin based on at least one, in particular aromatic, hydrocarbon compound, which is preferably selected from the group consisting of styrene, alpha-methylstyrene, para-methylstyrene and copolymers thereof.

The at least one resin of the reinforcing component preferably has a weight-average molecular weight M_{w} of 1,000 g/mol to 15,000 g/mol, more preferably 2,000 g/mol to 10,000 g/mol, determined by means of GPC (Test Ib).

The at least one resin of the reinforcing component has a mixed methylcyclohexane aniline (MMAP) cloud point (Test VI) of −10° C. to +30° C., preferably of 0° C. to +20° C.

The softening point of at least one resin of the reinforcing component is at least 140° C., preferably at least 150° C., determined according to Test IV.

The fraction of the reinforcing component, based on the total weight of the pressure-sensitive adhesive compound, is at least 2.5% by weight and at most 22% by weight, preferably at least 4% by weight and at most 18% by weight.

In the context of the present invention, the expression “substantially incompatible” or “substantially not compatible” is understood in particular to mean that the constituents or components referred to are at most 10% by weight, preferably at most 5% by weight, miscible with each other.

In the context of the present invention, the expression “substantially compatible” is understood in particular to mean that the constituents or components referred to are at least 90% by weight, preferably at least 95% by weight, miscible with each other.

### e) Further Adjuvants

In order to further adjust the property profile of the pressure-sensitive adhesive compound of the invention, additional adjuvants can be added to the pressure-sensitive adhesive compound. These are preferably adjuvants selected from the group consisting of primary antioxidants such as sterically hindered phenols, secondary antioxidants such as phosphites or thioethers, process stabilizers such as C radical scavengers, light stabilizers such as UV absorbers or sterically hindered amines, processing aids and further elastomers such as those based on pure hydrocarbons such as unsaturated polydienes, natural or synthetically generated polyisoprenes or polybutadienes, chemically substantially saturated elastomers, such as saturated ethylene-propylene copolymers, α-olefin copolymers, polyisobutylene, butyl rubber, ethylene-propylene rubber and functionalized hydrocarbons such as halogen-containing, acrylate-containing or vinyl ether-containing polyolefins. Furthermore, organic or inorganic fillers can be used, and also dyes and colour pigments. The pressure-sensitive adhesive compound can be black, grey, white or coloured accordingly.

### Self-Adhesive Products

A further subject of the present invention is, as set out, a self-adhesive product which is redetachable by extensive stretching and which has at least one layer of a pressure-sensitive adhesive compound of the invention.

The self-adhesive product according to the invention can be designed to be adhesive on one side or on both sides, i.e. on two sides, where the adhesive layer is preferably formed in each case from the pressure-sensitive adhesive compound of the invention.

Furthermore, the self-adhesive product according to the invention has at least one ply of a temporary carrier material (“release liner”).

This temporary carrier material is, in particular, a film-form material from which a pressure-sensitive adhesive compound layer can be detached, so that the remaining part of the self-adhesive tape can be subsequently brought into contact with a substrate to be bonded or with another material which is to form a bond with the remaining part of the self-adhesive tape.

The temporary carrier material is in particular a release paper or a release film, also called release liner, in any case a material not firmly connected to the pressure-sensitive adhesive compound layer, which is in particular furnished adhesively, so that detachment of a pressure-sensitive adhesive compound layer from it is made possible. It is therefore an aid for its production, storage or for further processing, for example by die-cutting.

Using the at least one abovementioned pressure-sensitive adhesive compound, the self-adhesive product according to the invention, according to preferred embodiments of the invention,
is a single-layer, double-sidedly self-adhesive tape, consisting of a single layer of the pressure-sensitive adhesive compound of the invention and thus what is called a transfer tape, or
is a multi-layer, double-sidedly self-adhesive tape, in which the layers each consist of the pressure-sensitive adhesive compound of the invention, or
is a multi-layer, double-sidedly self-adhesive tape with a permanent carrier, which is arranged either in a layer of the pressure-sensitive adhesive compound of the invention or between two layers of the pressure-sensitive adhesive compound of the invention,
is a multi-layer, single-sidedly self-adhesive tape with a layer of the pressure-sensitive adhesive compound of the invention and a permanent carrier,
in each case in combination with a temporary carrier material.

According to preferred embodiments of the invention, the self-adhesive product redetachable by extensive stretching has at least one ply of an extensible permanent carrier material.

Another subject of the present invention is therefore a self-adhesive product having a temporary carrier material and a permanent carrier, bearing at least one applied layer of the pressure-sensitive adhesive compound of the invention.

The invention also relates to a self-adhesive product having a temporary carrier material and a permanent carrier, bearing on both sides an applied layer of pressure-sensitive adhesive compound of the invention, the two layers of which may consist of the same or different adhesive compounds. In addition, the invention relates to a self-adhesive tape having a temporary carrier material and a permanent carrier, bearing on one side an applied layer of a pressure-sensitive adhesive compound of the invention and on the other side an applied further, non-inventive adhesive compound. The latter may be pressure-sensitive adhesive or non-pressure-sensitive adhesive and/or heat-sealable.

Thus, the double-sided products can have a symmetrical or an asymmetrical product structure.

Single-layer, double-sidedly self-adhesive tapes consisting of a single layer of a pressure-sensitive adhesive compound of the invention in combination with a temporary carrier material are also preferred.

In addition, an embodiment of the self-adhesive product is preferred, in which the permanent carrier consists only of a single layer of a polymer film.

Further preferred is a self-adhesive product which is constructed multi-layered, one-sided from at least one layer of the pressure-sensitive adhesive compound of the invention and a permanent carrier. The pressure-sensitive adhesive compound of the invention preferably represents the externally directed tacky layer of the self-adhesive product, so that it is—independently of a temporary carrier material—available for bonding to a substrate.

The permanent carrier in all embodiments is preferably a film, in particular a stretchable film.

In particular, the inventive concept embraces structures with an extensible permanent carrier in the middle of the self-adhesive product, in particular in the middle of a single layer of the pressure-sensitive adhesive compound of the invention, wherein the extensibility of the intermediate carrier must be sufficient to ensure detachment of the adhesive strip by extensive stretching. For example, very stretchable films can serve as permanent carriers. Examples of advantageously employable extensible permanent carriers are transparent versions from WO 2011/124782 A1, DE 10 2012 223 670 A1, WO 2009/114683 A1, WO 2010/077541 A1, WO 2010/078396 A1.

However, the permanent carrier does not need to be transparent. It can in particular also be black, grey, white or coloured.

For the production of the permanent carrier film, film-forming or extrusion-capable polymers are used, which can also be monoaxially or biaxially oriented.

According to preferred embodiments, the extensible permanent carrier material is a stretchable film.

According to preferred embodiments, the film is made of at least one polyolefin. Preferred polyolefins are prepared from ethylene, propylene, butylene and/or hexylene, where it is possible in each case to polymerize the pure monomers or to copolymerize mixtures of the monomers mentioned. It is possible via the polymerization process and by the choice of monomers to control the physical and mechanical properties of the polymer film, for example the softening temperature and/or the elongation at break.

Polyurethanes can also be used excellently as starting materials for extensible permanent carrier layers. Polyurethanes are chemically and/or physically crosslinked polycondensates that are typically formed from polyols and isocyanates. According to the nature and use ratio of the individual components, extensible materials that can be used advantageously in the context of this invention are obtainable. Raw materials available to the formulator for this purpose are specified, for example, in EP 0 894 841 B1 and EP 1 308 492 B1. The skilled person is aware of other raw materials from which permanent carrier layers according to the invention can be constructed. Polyesterpolyurethanes, polyetherpolyurethanes and polycaprolactonepolyurethanes are mentioned here as examples of polyurethanes which can be advantageously used as a base material for permanent carriers in the sense of this invention.

Furthermore, it is advantageous to use materials based on ethylene-vinyl acetate (EVA) copolymers in permanent carrier layers in order to realize extensibility.

Therefore preferred is a self-adhesive product according to the invention which as extensible permanent carrier material has at least one stretchable film which is made preferably of at least one material selected from the group consisting of polyolefins, such as ethylene, propylene, butylene and hexylene, polyurethanes, polyesterpolyurethanes, polyetherpolyurethanes, polycaprolactonepolyurethanes, ethylene-vinyl acetate (EVA) copolymers and rubber-based materials.

Further preferably, the carrier is a foam carrier, particularly preferably a foam carrier made of a PE or PU foam. The foam may have any known form of foam cells, i.e. may be open-cell or closed-cell. The foaming may have been produced by chemical or physical foaming agents, by injection of gas or, in particular, air (“frothing”), or by introduction of hollow spheres, without this enumeration being conclusive, but to be understood merely as an example. Specific examples are hollow glass spheres, hollow ceramic spheres, hollow metal spheres and expanded, expandable and pre-expanded microballoons. Combinations of various mentioned and other foaming methods are also possible.

For the production of a permanent carrier, it may also be appropriate here to add additives and other components that improve the film-forming properties, if present and desired reduce the tendency to form crystalline segments, and/or selectively improve or else possibly impair the mechanical properties.

The permanent carriers can be of multi-ply design.

In addition, the permanent carriers may have outer layers, for example barrier layers, which prevent penetration of components from the adhesive compound into the permanent carrier or vice versa. These outer layers may also have barrier properties in order thus to prevent through-diffusion of water vapor and/or oxygen.

For better anchoring of the pressure-sensitive adhesive compounds on the permanent carrier, the permanent carriers can be pre-treated with the known measures such as corona, plasma or flaming. The utilization of a primer is also possible. Ideally, however, it is possible to dispense with pretreatment.

The back of the permanent carrier may have been subjected to an antiadhesive physical treatment or coating.

The thickness of the permanent carrier layer is typically in the range of 10 to 200 μm, preferably between 20 and 100 μm.

The strain (“stripping force”, Test VII) at 50% stretch should be less than 20 N/cm, preferably less than 10 N/cm, to allow easy detachment without too much force being expended.

### Particularly Advantageous is a Self-Adhesive Product Consisting of

a single-layer permanent carrier, preferably composed of polyurethane, wherein the carrier has an elongation at break of at least 100%, preferably at least 300%, and optionally a resilience of more than 50% (Test VIII), and
the carrier bears on both sides a respective applied layer of a pressure-sensitive adhesive compound of the invention, wherein preferably the composition of the adhesive compounds is identical.

### Particularly Advantageous Additionally is a Self-Adhesive Product Consisting of

a single-layer permanent carrier, preferably containing polyolefin, wherein the carrier has an elongation at break of at least 100%, preferably at least 300%, and optionally a resilience of less than 50% (Test VIII), and
the carrier bears on both sides a respective applied layer of a pressure-sensitive adhesive compound of the invention, wherein preferably the composition of the adhesive compounds is identical.

For the purposes of this invention, the general terms “self-adhesive product” and “self-adhesive tape” include all flat structures such as films or film portions extended in two dimensions, tapes with extended length and limited width, tape portions and the like, and ultimately also cut-outs, die-cuts or labels.

The self-adhesive product thus has a longitudinal extent and a lateral extent. The adhesive tape also has a thickness that runs perpendicular to the two extents, the lateral extent and longitudinal extent possibly being many times greater than the thickness. The thickness is as similar as possible over the entire surface area of the self-adhesive product determined by length and width, preferably substantially the same.

Typical converted forms of the self-adhesive product according to the invention are adhesive tape rolls and self-adhesive strips, as obtained, for example, in the form of die-cuts.

Preferably, all layers are essentially in the shape of a cuboid. Further preferably, all layers are bonded to one another over the full area.

Optionally, a non-adhesive grip tab area can be provided, starting from which the detachment process can be carried out.

The self-adhesive product preferably has a thickness of from 20 μm to 2,000 μm, further preferably from 30 to 1,500 μm, especially preferably from 50 to 1,000 μm or 100 μm, 150 μm, 200 μm, 250 μm or 500 μm, where the temporary carrier material is not included. Preferred is an embodiment of the self-adhesive product in which the permanent carrier has a thickness between 20 and 100 μm, preferably 30 μm to 60 μm, and identical pressure-sensitive adhesive compound layers of the invention on the permanent carrier each have a thickness between 20 and 100 μm, preferably 30 μm to 60 μm.

In addition, an embodiment of the self-adhesive product is preferred in which no permanent carrier is contained and a pressure-sensitive adhesive compound of the invention is present as a singular layer on a temporary carrier material. The pressure-sensitive adhesive compound layer preferably has a thickness between 100 μm and 2,000 μm, in particular between 200 μm and 1,500 μm or between 400 μm and 1200 μm.

Preferably, the self-adhesive product according to the invention redetachable by extensive stretching can be removed by extensively stretching it preferably substantially in the bond plane, that is, at a removal angle of about 0°, whereby it can be redetached without residue and non-destructively.

Removal, though, is also possible under other removal angles such as 45° or 90°.

### Production Processes

The pressure-sensitive adhesive compound for the self-adhesive product according to the invention is applied either to one side of a temporary carrier material or to one side of a permanent carrier. The pressure-sensitive adhesive compound can be applied to the carrier according to methods known to the skilled person, for example by means of squeegee methods, nozzle squeegee methods, rolling rod nozzle methods, extrusion nozzle methods, casting nozzle methods and casting methods. Likewise in accordance with the invention are application processes such as roll application processes, printing processes, screen-printing processes, halftone roll processes, inkjet processes and spraying processes.

A preferred coating variant is solvent-based. For this purpose, the constituents of the pressure-sensitive adhesive compound(s) are dissolved in a suitable solvent or solvent mixture and then coated from solution and the coated material is dried. Suitable solvents, that can also be used in combination, are aliphatic (for example pentane, hexane, heptane, octane and their structural isomers), cycloaliphatic (for example cyclohexane and methylcyclohexane) and aromatic hydrocarbons (for example toluene, xylene), especially in combination with ketones (for example acetone, 2-butanone, isobutyl ketone) or esters (for example ethyl acetate, butyl acetate, propyl acetate, isopropyl acetate). In an advantageous procedure, a mixture of toluene and ethyl acetate is used. A mixture of methylcyclohexane and an ester such as ethyl acetate or, in particular, butyl acetate is very advantageous. A mixture of cyclohexane and an ester, in particular butyl acetate, is also advantageous.

Another preferred production variant are hotmelt processes in which the pressure-sensitive adhesive compound is mixed by means of a compounding unit and applied in particular directly thereafter (“inline”) to the carrier material by means of extrusion and/or nozzle and/or calender. However, the application process does not need to be one of direct coating. The pressure-sensitive adhesive compound can also be coated in a different way first and laminated onto the carrier in a second step. Subsequently, if desired, further layers or plies of material can be coated or laminated on inline or offline, thus allowing multi-layer/multi-ply product constructions to be produced as well. Such further layers can introduce special additional properties into the self-adhesive product, such as the mechanical properties, for example. They may also promote anchoring between the adhesive compound and the carrier or suppress the migration of individual constituents from one layer into the other.

For product structures with a permanent carrier, a pressure-sensitive adhesive compound layer can be applied by direct coating to the permanent carrier material or by lamination, in particular hot lamination.

### Use

The self-adhesive products according to the invention are excellently suited for long-term-stable permanent bonding, in which a high thermal shear strength and also separability of the bonded assembly is required even after storage under hot and humid conditions. The need for separability of a permanent bond can exist for reworking purposes (if a bond is to be corrected in the process of producing an object), for repair purposes (if a defective component of the bonded assembly is to be replaced) or for recycling purposes (if after the useful life of the bonded assembly, it is to be disposed of as separate materials). Self-adhesive products with the pressure-sensitive adhesive compounds described here have also proven to be advantageous, particularly in connection with polar surfaces, such as steel, and also low-energy surfaces such as PP/EPDM, PP/EPM and PP/EPR. Therefore, a further subject of the present invention is the use of the pressure-sensitive adhesive compound of the invention or the adhesive tape of the invention for bonding a substrate containing ethylene (co)polymer, propylene (co)polymer, EPR, EPM and/or EPDM or else another plastic. In particular, the pressure-sensitive adhesive compound of the invention or the adhesive tape of the invention is used for bonding a mounted component containing ethylene (co)polymer, propylene (co)polymer, EPR, EPM and/or EPDM or else another plastic such as ABS or polycarbonate in or on an automobile/vehicle. The longevity of the pressure-sensitive adhesive compound of the invention also allows the bonding of other materials such as glass, ceramic and metal.

Therefore, a further subject of the present invention is the use of the pressure-sensitive adhesive compound of the invention or the adhesive tape of the invention for bonding other substrates such as, in particular, other plastics and metals.

A further subject of the present invention is thus also an glued composite comprising at least one self-adhesive product according to the invention and at least one substrate which is in contact with at least one adhesive layer of the self-adhesive product.

A further subject of the present invention is an adhesively bonded assembly comprising at least two substrates and at least one self-adhesive product according to the invention, which bonds the two substrates to each other.

Another subject of the present invention is an assembly of a single-sidedly self-adhesive product and a substrate which is in contact with at least one pressure-sensitive adhesive layer of the single-sidedly self-adhesive product.

All the above observations apply to the substrates and the self-adhesive product.

The present invention is explained in more detail using the following examples, which are not to be understood in any way as a restriction of the concept of the invention.

### TEST METHODS

The measurements are carried out—unless explicitly stated otherwise—under test conditions of 23±1° C. and 50±5% relative humidity.

### Test I—Molar Mass (GPC)

### (a) Peak Molar Mass of Individual Block Copolymer Modes

Polymers are polymodal systems in terms of molecular mass distribution. Mixtures of different polymers can be understood as multimodal systems, with each polymer contributing its own molar mass distribution. Mixtures of block copolymers with structures having different molar mass distributions can also be understood as multimodal systems. Each block copolymer then contributes its own molar mass distribution. For simplicity, these are called block copolymer modes here.

GPC is a metrological method for determining the molar mass of individual polymer modes in mixtures of different polymers. For the block copolymers produced by living anionic polymerization which can be used in the sense of this invention, the molar mass distributions are typically sufficiently narrow, so that polymer modes which can be assigned to triblock copolymers, diblock copolymers or multiblock copolymers are sufficiently resolved from each other in the elugram. It is then possible to read off the peak molar mass for the individual polymer modes from the elugrams.

Peak molar masses (peak MM) are determined via gel permeation chromatography (GPC). The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and 10⁴ Å and 10⁶ Å each with ID 8.0 mm×300 mm. The sample concentration is 4 g/I and the flow rate is 1.0 ml per minute. The calibration is carried out using the commercially available ReadyCal kit Poly(styrene) high from PSS Polymer Standard Service GmbH, Mainz. (μ=μm; 1 Å=10⁻¹⁰ m).

### (b) Weight-Average Molar Mass, Particularly of Plasticizers

The weight-average molecular weight M_{w} is determined via gel permeation chromatography (GPC). The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and 10⁴ Å and 10⁶ Å each with ID 8.0 mm×300 mm. The sample concentration is 4 g/l and the flow rate is 1.0 ml per minute. The calibration is carried out using the commercially available ReadyCal kit Poly(styrene) high from PSS Polymer Standard Service GmbH, Mainz.

### Test II—Peel Adhesion, Steel

The determination of the peel adhesion (according to AFERA 5001) is conducted as follows. The defined adhesion substrate used is a polished steel plate 2 mm in thickness. The bondable sheetlike element to be examined (500 μm pressure-sensitive adhesive layer as a transfer adhesive layer is reinforced on the back with a 75 μm polyester film) is cut to a width of 20 mm and a length of about 25 cm, unless otherwise specified, provided with a handling section and immediately thereafter pressed five times with a steel roller of 4 kg advanced at a rate of 10 m/min onto the respectively chosen adhesion substrate. Immediately thereafter, the bondable sheetlike element is peeled from the adhesion substrate at an angle of 180° with a tensile tester (from Zwick) at a velocity v=300 mm/min, and the force required for this purpose at room temperature is measured. The measured value (in N/cm) is obtained as the average value from three individual measurements.

### Test III—Tear Resistance

For the tear resistance tests, adhesive tape specimens were produced as follows. Pressure-sensitive adhesive coatings in 500 μm were tested as single-layer adhesive strip specimens. From the adhesive tape to be examined, 10 strips each of 12 mm width and 55 mm length are prepared, which on one side over a length of 10 mm are shaped as an isosceles triangle.

These strips are bonded over a length of 45 mm to a polycarbonate sheet conditioned with ethanol, so that a 10 mm long tab protrudes which lies opposite the side pointed by way of the isosceles triangle; that is, which lies at the rectangular end of the strip. A second polycarbonate sheet is applied to the second surface of the bonded strips, in such a way that the two polycarbonate sheets lie flush one on top of the other. The assembly is rolled down 10 times with a 4 kg roller (five times back and forth). After an adhesion time of 24 h, the strips are stripped manually from the adhesive joint, using the tab, at a 180° angle. An evaluation is made as to how many specimens can be redetached without any residue. Tear resistance is reported as a percentage in terms of torn adhesive strips. 0% corresponds to the case that none of the 10 adhesive strips has been torn during the detachment test carried out by extensive stretching. 80% corresponds to the case that 8 adhesive strips of the 10 adhesive strips have been torn during the detachment test carried out by extensive stretching.

Assemblies were exposed to different storage conditions after the adhesion time had ended: (a) 7 days 85° C., (b) 7 days 85° C. and 85% relative humidity. The assemblies were then reconditioned for 24 h at 23° C. and 50% relative humidity prior to the tear resistance measurement.

### Test IV—(Tackifier) Resin Softening Temperature

For individual substances: The (tackifier) resin softening temperature (softening point; soft. point) is carried out according to the relevant method, which is known as ring & ball and is standardized according to ASTM E28.

### Test V—DACP

5.0 g of test substance (the tackifier resin sample to be examined) are weighed into a dry sample glass, and 5.0 g of xylene (isomer mixture, CAS [1330-20-7], ≥98.5%, Sigma-Aldrich #320579 or comparable) are added. The test substance is dissolved at 130° C. and then cooled down to 80° C. If xylene escapes, it is made up with additional xylene, so that 5.0 g of xylene are present again. Subsequently, 5.0 g of diacetone alcohol (4-hydroxy-4-methyl-2-pentanone, CAS [123-42-2], 99%, Aldrich #H41544 or comparable) are added. The sample glass is shaken until the test substance has dissolved completely. For this purpose, the solution is heated to 100° C. The sample glass containing the resin solution is then placed into a Novomatics Chemotronic Cool cloud point measuring device, where it is heated to 110° C. It is cooled down at a cooling rate of 1.0 K/min. The cloud point is detected optically. For this purpose, that temperature at which the turbidity of the solution is 70% is registered. The result is reported in ° C. The lower the DACP value, the higher the polarity of the test substance.

### Test VI—MMAP

5.0 g of test substance (the tackifier resin specimen under investigation) are weighed into a dry sample glass and 10 mL of dry aniline (CAS [62-53-3], 99.5%, Sigma-Aldrich #51788 or comparable) and 5 mL of dry methylcyclohexane (CAS [108-87-2], ≥99%, Sigma-Aldrich #300306 or comparable) are added. The sample glass is shaken until the test substance has dissolved completely. For this purpose, the solution is heated to 100° C. The sample glass containing the resin solution is then placed into a Novomatics Chemotronic Cool cloud point measuring device, where it is heated to 110° C. It is cooled down at a cooling rate of 1.0 K/min. The cloud point is detected optically. For this purpose, that temperature at which the turbidity of the solution is 70% is registered. The result is reported in ° C. The lower the MMAP, the higher the aromaticity of the test substance.

### Test VII—Stripping Force

The detachment force (stripping force or stripping strain) is determined with a sample of the object to be examined, more particularly the self-adhesive product or permanent carrier, with the dimensions 50 mm length×20 mm width with a non-adhesive grip tab area at the upper end. The sample is bonded between two congruently arranged steel plates with a dimension of 50 mm×30 mm with a contact pressure of 50 newtons in each case. The steel plates each have a hole to accommodate an S-shaped steel hook at their lower end. The lower end of the steel hook carries another steel plate, which can be used to fix the test arrangement for measurement in the lower jaw of a tensile testing machine. The bonds are stored for a time of 24 hours at +40° C. After reconditioning to room temperature, the sample strip is extracted at a pulling speed of 1,000 mm per minute parallel to the bonding plane and contact-free to the edge areas of the two steel plates. The detachment force required is measured in newtons (N). The average value of the stripping strain values (in N per mm²) is reported, measured in the area in which the self-adhesive product has detached from the steel substrates over a bonding length between 10 mm and 40 mm.

### Test VIII—Extensibility, Resilience

To measure the resilience, the respective objects, in particular self-adhesive product or permanent carrier, are extended by 100%, held at this extension for 30 s and then relaxed. After a waiting time of 1 min, the length is measured again.

The resilience is then calculated as follows: RV=((L₁₀₀−L_{end})/L₀)·100 where RV=resilience in %.
L₁₀₀: length of the adhesive strip after extension by 100%
L₀: length of the adhesive strip prior to extension
L_{end}: length of the adhesive strip after relaxation for 1 min.

The resilience corresponds here to the elasticity.

The elongation at break, tensile strength and stress at 50% elongation are measured in accordance with DIN 53504 using dumbbell specimens of size S3 at a separation speed of 300 mm per minute. The test conditions are 23° C. and 50% rel. air humidity.

### Test IX—Polyvinylaromatic Fraction

The fraction of polyvinylaromatic blocks in hydrogenated polyvinylaromatic-polydiene block copolymers is determined by ¹³C-NMR, unless otherwise known. Using the example of the determination of the polystyrene fraction in hydrogenated polystyrene-polydiene block copolymers (SEBS), the ¹³C-NMR is explained below. From the ¹³C spectrum, the average value is formed from two integrals, namely the styrene C signal at around 144 to 146 ppm and the styrene CH at around 125 to 127 ppm. This average value is set for SEBS in relation to the butylene integral (hydrogenated 1,2-polybutadiene repeating units), namely the CH3 signal at around 10 ppm, and to the ethylene integral (hydrogenated 1,4-polybutadiene repeating units), which can be calculated from the total olefinic integral at around 20 to 50 ppm. The fractions thus obtained, in mol %, are then converted to % by weight.

### I. Raw Materials Used

TABLE 2
Chemicals used

| Component | Chemical | Description | Manufacturer |
|---|---|---|---|
| Elastomer | Kraton ® G1654 | SEBS; | Kraton Corp. |
| | | PS fraction 31% by weight; | |
| | | Diblock fraction: 0% by weight | |
| | | Peak Mw*: 160 000 g/mol | |
| | Kraton ® G1657 | SEBS; | Kraton Corp. |
| | | PS fraction 13% by weight; | |
| | | Diblock fraction: 29% by weight | |
| | | Peak Mw*: 120 000 g/mol | |
| | Kraton ® G1726 | SEBS; | Kraton Corp. |
| | | PS fraction 30% by weight; | |
| | | Diblock fraction: 70% by weight | |
| | | Peak Mw*: 65 000 g/mol | |
| Resin | Regalite ® | C₉ HC resin; | Synthomer |
| | R1125 | Soft. point: 125° C. | |
| | | MMAP: 88° C. | |
| | | DACP: 56° C. | |
| | | Fully hydrogenated | |
| | Regalite ® | C₉ HC resin; | Synthomer |
| | R1100 | Soft. point: 100° C. | |
| | | MMAP: 75° C. | |
| | | DACP: 45° C. | |
| | | Fully hydrogenated | |
| | Foral ® 105E | Pentaerythritol ester of | Synthomer |
| | | hydrogenated rosin | |
| | | Soft. point: 105° C. | |
| | | MMAP: 16° C. | |
| | | DACP: −50° C. | |
| Plasticizer | TerPIB 2600 | Polybutene | ter Hell |
| | | Peak Mw: 11 000 g/mol | |
| | | Mw: 9200 g/mol | |
| Reinforcing | Endex 155 | Aromatic HC resin | Synthomer |
| component | | Soft. point: 153° C. | |
| | | Mw: 6600 g/mol | |
| | | MMAP: 15° C. | |
| Adjuvants | Irganox ® 1726 | Ageing inhibitor | BASF |

SEBS: Styrene-ethylene/butylene-styrene block copolymer
PS fraction: Polystyrene fraction
Peak Mw: Peak molecular weight
Peak Mw*: Peak molecular weight of the triblock copolymer
HC resin: Hydrocarbon resin
Soft. point: Softening point
Mw: Weight-average molecular weight

### II. EXPERIMENTS

A series of test adhesive tape specimens were generated.

### Production Process (Hotmelt Process):

The solvent-free production of pressure-sensitive adhesive formulations was carried out by means of a planetary roller extruder (PWE), which comprised an intake area and two process parts. The run-in rings had increasing diameter in process direction. Even though different spindle fittings were suitable, preference was given to fittings that were at least ¾ of the maximum fitting number in the first process part. The elastomer components and the reinforcing component were metered in the intake of the PWE. The resin components were melted and added in the first process part of the PWE. Particularly suitable for the production of homogeneous mixtures was a resin split, in which part of the resin was added in the intake area and the rest downstream in the first process part. Particularly suitable was the addition of both fractions in liquid form via a side feed or start-up rings, the first fraction being around 30% by weight of the total amount of resin, and unless otherwise indicated, the process was carried out in this way. It would also be suitable to add the first resin fraction in solid form in the intake of the PWE or via a side feed in the intake area. Coating was carried out by introducing the hot pressure-sensitive adhesive compound into a 2-roll calender to a thickness of 500 μm.

The properties listed in the tables were then tested using 500 μm thick adhesive transfer tapes.

Examples marked with “I” are examples according to the invention. Examples marked with “C” are comparative examples.

TABLE 3

| | | Example I1 | Example I2 | Example I3 | Example C1 |
|---|---|---|---|---|---|
| (a) Elastomer | Kraton | 34.0% by | 33.3% by | 32.7% by | 35.0% by |
| component | G1654 | weight | weight | weight | weight |
| | Kraton | 14.5% by | 14.2% by | 14.0% by | 15.0% by |
| | G1726 | weight | weight | weight | weight |
| Diblock | | 20.9% by | 20.9% by | 21.0% by | 21.0% by |
| fraction | | weight | weight | weight | weight |
| Elastomer | | 48.5% by | 47.5% by | 46.7% by | 50.0% by |
| fraction | | weight | weight | weight | weight |
| (b) Tackifier | Regalite | 12.6% by | 12.4% by | 12.2% by | 13.0% by |
| resin | R1125 | weight | weight | weight | weight |
| component | Regalite | 30.6% by | 30.0% by | 29.4% by | 31.5% by |
| | R1100 | weight | weight | weight | weight |
| Total tackifier | | 43.2% by | 42.4% by | 41.6% by | 44.5% by |
| resin | | weight | weight | weight | weight |
| (c) Plasticizer | terPib 2600 | 4.9% by | 4.8% by | 4.7% by | 5.0% by |
| component | | weight | weight | weight | weight |
| (d) | Endex 155 | 2.9% by | 4.8% by | 6.5% by | —/— |
| Reinforcing | | weight | weight | weight | |
| component | | | | | |
| (e) Adjuvants | Irganox | 0.5% by | 0.5% by | 0.5% by | 0.5% by |
| | 1726 | weight | weight | weight | weight |
| Tear rate | | 20% | 0% | 0% | 40% |
| 85° C. / 85% | | | | | |
| rel. h .* | | | | | |
| Tear rate | | 0% | 10% | 0% | 0% |
| 85° C.* | | | | | |
| Peel adhesion | | 26.9 N/cm | 27.4 N/cm | 29.4 N/cm | 20.7 N/cm |
| 180° (steel)** | | | | | |

TABLE 4

| | | Example I4 | Example I5 | Example I6 | Example C2 |
|---|---|---|---|---|---|
| (a) Elastomer | Kraton | 31.9% by | 31.3% by | 30.8% by | 32.5% by |
| component | G1654 | weight | weight | weight | weight |
| | Kraton | 21.3% by | 20.9% by | 20.6% by | 21.7% by |
| | G1726 | weight | weight | weight | weight |
| Diblock | | 28.0% by | 28.0% by | 28.1% by | 28.1% by |
| fraction | | weight | weight | weight | weight |
| Total | | 53.2% by | 52.2% by | 51.4% by | 54.2% by |
| elastomer | | weight | weight | weight | weight |
| (b) Tackifier | Regalite | 11.6% by | 11.4% by | 11.2% by | 11.8% by |
| resin | R1125 | weight | weight | weight | weight |
| component | Foral 105E | 26.5% by | 26.0% by | 25.7% by | 27.0% by |
| | | weight | weight | weight | weight |
| Total tackifier | | 38.1% by | 37.4% by | 36.9% by | 38.8% by |
| resin | | weight | weight | weight | weight |
| (c) Plasticizer | TerPib 2600 | 4.8% by | 6.6% by | 6.5% by | 6.5% by |
| component | | weight | weight | weight | weight |
| (d) | Endex 155 | 3.4% by | 3.3% by | 4.7% by | —/— |
| Reinforcing | | weight | weight | weight | |
| component | | | | | |
| (e) Adjuvants | Irganox | 0.5% by | 0.5% by | 0.5% by | 0.5% by |
| | 1726 | weight | weight | weight | weight |
| Tear rate | | 0% | 10% | 0% | 50% |
| 85° C. / 85% | | | | | |
| rel. h.* | | | | | |
| Tear rate | | 0% | 0% | 0% | 0% |
| 85° C.* | | | | | |
| Peel adhesion | | 20.5 N/cm | 18.8 N/cm | 28.7 N/cm | 18.8 N/cm |
| 180° (steel)** | | | | | |

TABLE 5

| | | Example I7 | Example I8 | Example C3 | Example I9 |
|---|---|---|---|---|---|
| (a) | Kraton | 26.2% by | 25.8% by | 27.5% by | 28.0% by |
| Elastomer | G1654 | weight | weight | weight | weight |
| component | Kraton | 26.2% by | 25.8% by | 27.5% by | 14.0% by |
| | G1726 | weight | weight | weight | weight |
| | Kraton | | | | 4.8% by |
| | G1657 | | | | weight |
| Diblock | | 35.0% by | 35.0% by | 35.0% by | 23.9% by |
| fraction | | weight | weight | weight | weight |
| Total | | 52.4% by | 51.6% by | 55.0% by | 46.8% by |
| elastomer | | weight | weight | weight | weight |
| (b) Tackifier | Regalite | 11.3% by | 11.3% by | 12.0% by | 12.1% by |
| resin | R1125 | weight | weight | weight | weight |
| component | Regalite | 26.2% by | 25.8% by | 27.5% by | 29.4% by |
| | R1100 | weight | weight | weight | weight |
| Total tackifier | | 37.5% by | 37.1% by | 39.5% by | 41.5% by |
| resin | | weight | weight | weight | weight |
| (c) | TerPib 2600 | 4.8% by | 4.7% by | 5.0% by | 4.7% by |
| Plasticizer | | weight | weight | weight | weight |
| component | | | | | |
| (d) | Endex 155 | 4.8% by | 6.1% by | —/— | 6.5% by |
| Reinforcing | | weight | weight | | weight |
| component | | | | | |
| (e) Adjuvants | Irganox | 0.5% by | 0.5% by | 0.5% by | 0.5% by |
| | 1726 | weight | weight | weight | weight |
| Tear rate | | 10% | 10% | 70% | 10% |
| 85° C. / 85% | | | | | |
| rel. h .* | | | | | |
| Tear rate | | 0% | 0% | 20% | 0% |
| 85° C.* | | | | | |
| Peel | | 24.5 N/cm | 23.6 N/cm | 21.5 N/cm | 26.8 N/cm |
| adhesion | | | | | |
| 180° (steel)** | | | | | |

Surprisingly, the examples according to the invention containing a reinforcing component in combination with the other constituents—compared to a reference system without this reinforcing component—show an improvement in the detachment characteristics, where they can be detached tear-free. Surprisingly, the detachment characteristics are improved in particular after the respective bonded assembly has been stored under hot and humid conditions, although there are no differences in the tear characteristics when stored purely at temperature (also 85° C.).

1. A pressure-sensitive adhesive compound containing:
a) at least 28% by weight and at most 60% by weight of an elastomer component, wherein
i. the elastomer component contains at least 60% by weight based in each case on the elastomer component, of at least one hydrogenated polyvinylaromatic-polydiene block copolymer having a polyvinylaromatic fraction of at least 18% by weight and a peak molecular weight of 100,000 to 500,000 g/mol, determined according to GPC (Test I),
ii. the polydiene blocks are substantially fully hydrogenated,
iii. the hydrogenated polyvinylaromatic-polydiene block copolymer has an ABA structure, (AB)ₙZ structure with n=2 or radial (AB)ₙ structure or radial (AB)ₙ−Z structure with n≥3, wherein A=polyvinylaromatic, B=ethylene and butylene or ethylene and propylene and Z=derivative of a coupling substance, and
iv. the elastomer component contains at least one kind of a hydrogenated diblock copolymer having an A′B′ structure or (A′B′)ₙZ structure with n=1, wherein A′=polyvinylaromatic, B′=ethylene and butylene or ethylene and propylene, Z=derivative of a coupling substance, or, A′=A and B′=B,
b) a tackifier resin component,
c) optionally a plasticizer component,
d) at least 2.5% by weight to 22% by weight, of a reinforcing component which is at least one resin having an MMAP value between −10° C. and +30° C., and a softening point of at least 140° C.,
e) optionally further adjuvants,
the fraction of the elastomer component being based on the total weight of the pressure-sensitive adhesive compound.

2. A pressure-sensitive adhesive compound according to claim 1, containing:
c) at least 2% by weight and not more than 25% by weight of a plasticizer component.

3. A pressure-sensitive adhesive compound according to claim 1 wherein the fraction of elastomer component in the layer of the pressure-sensitive adhesive compound is 35% by weight to 58% by weight, based in each case on the total weight of the pressure-sensitive adhesive compound.

4. The pressure-sensitive adhesive compound according claim 1, wherein the polyvinylaromatic-polydiene block copolymers have a polyvinylaromatic fraction of 18% by weight to 35% by weight.

5. The pressure-sensitive adhesive compound claim 1, wherein the at least one resin of the reinforcing component is at least one resin based on at least one, hydrocarbon compound, selected from the group consisting of styrene, alpha-methylstyrene, para-methylstyrene and copolymers thereof, wherein the at least one resin of the reinforcing component has a weight-average molecular weight M_{w} of 1,000 g/mol to 15,000 g/mol, determined by means of GPC.

6. The pressure-sensitive adhesive compound according claim 1, wherein the elastomer component contains up to 35% by weight, based on the elastomer component, of the at least one kind of the hydrogenated diblock copolymer.

7. The pressure-sensitive adhesive compound according to claim 6, wherein the at least one diblock copolymer has a peak molecular weight, determined by means of GPC, of <100,000 g/mol.

8. The pressure-sensitive adhesive compound according to claim 1, wherein the fraction of tackifier resin component is 28% to 55% by weight, based in each case on the total weight of the pressure-sensitive adhesive compound.

9. The pressure-sensitive adhesive compound according to claim 1, wherein the at least one tackifier resin of the tackifier resin component is selected from the group consisting of: resins based on dicyclopentadiene, hydrocarbon resins based on C₅, C₅/C₉ or C₉ monomer streams, polyterpene resins based on α-pinene and/or β-pinene and δ-limonene and polymers of pure C₈ or C₉ aromatics, the resin being partially or, fully hydrogenated.

10. The pressure-sensitive adhesive compound according to claim 1, wherein the fraction of plasticizer component in the pressure-sensitive adhesive compound is 2% to 20% by weight, based in each case on the total weight of the pressure-sensitive adhesive compound.

11. The pressure-sensitive adhesive compound according to claim 1, wherein the plasticizer component is at least one plasticizer selected from the group consisting of ethylene/propylene copolymer, ethylene/butylene copolymer and butylene/isobutylene (co)polymer.

12. The pressure-sensitive adhesive compound according to claim 11, wherein the plasticizer has a weight-average molar mass of at least 3,000 g/mol and at most 20,000 g/mol and which a butylene/isobutylene (co)polymer.

13. A self-adhesive product redetachable by extensive stretching, comprising at least one layer of a pressure-sensitive adhesive compound according to claim 1 and at least one ply of a temporary carrier material.

14. The self-adhesive product redetachable by extensive stretching according to claim 13, wherein the self-adhesive product comprises at least one ply of an extensible permanent carrier material.

15. The self-adhesive product redetachable by extensive stretching according to claim 14, wherein the extensible permanent carrier material is a stretchable.

16. The self-adhesive product redetachable by extensive stretching according to claim 13, wherein the self-adhesive product is a
is a single-layer, double-sided self-adhesive tape, consisting of a single layer of the pressure-sensitive adhesive compound containing:
a) at least 28% by weight and at most 60% by weight of an elastomer component, wherein,
i. the elastomer component contains at least 60% by weight based in each case on the elastomer component, of at least one hydrogenated polyvinylaromatic-polydiene block copolymer having a polyvinylaromatic fraction of at least 18% by weight and a peak molecular weight of 100,000 to 500,000 g/mol, determined according to GPC (Test I),
ii. the polydiene blocks are substantially fully hydrogenated,
iii. the hydrogenated polyvinylaromatic-polydiene block copolymer has an ABA structure, (AB)ₙZ, structure with n=2 or radial (AB)ₙ structure or radial (AB)ₙ−Z structure with n≥3, wherein A=polyvinylaromatic, B=ethylene and butylene or ethylene and propylene and Z=derivative of a coupling substance, and
iv. the elastomer component contains at least one kind of a hydrogenated diblock copolymer having an A′B′ structure or (A′B′)ₙZ with n=1,
wherein A′=polyvinylaromatic, B′=ethylene and butylene or ethylene and propylene, Z=derivative of a coupling substance, or A′=A and B′=B,
b) a tackifier resin component,
c) optionally a plasticizer component,
d) at least 2.5% by weight to 22% by weight, of a reinforcing component which is at least one resin having an MMAP value between −10° C. and +30° C., and a softening point of at least 140° C.,
e) optionally further adjuvants,
the fraction of the elastomer component being based on the total weight of the pressure-sensitive adhesive compound,
in combination with a temporary carrier material.

17. The self-adhesive product redetachable by extensive stretching according to claim 13, wherein the self-adhesive product consists of
a single-layer permanent carrier, contains a polyolefin, wherein the carrier has an elongation at break of at least 100%, and
the carrier bears on both sides a respective applied layer of the pressure-sensitive adhesive compound containing:
a) at least 28% by weight and at most 60% by weight of an elastomer component, wherein
i. the elastomer component contains at least 60% by weight based in each case on the elastomer component, of at least one hydrogenated polyvinylaromatic-polydiene block copolymer having a polyvinylaromatic fraction of at least 18% by weight and a peak molecular weight of 100,000 to 500,000 g/mol, determined according to GPC (Test I),
ii. the polydiene blocks are substantially fully hydrogenated,
iii. the hydrogenated polyvinylaromatic-polydiene block copolymer has an ABA structure, (AB)ₙZ structure with n=2 or radial (AB)ₙZ structure or radial (AB)ₙ−Z structure with n≥3, wherein A=polyvinylaromatic, B=ethylene and butylene or ethylene and propylene and Z=derivative of a coupling substance, and
iv. the elastomer component contains at least one kind of a hydrogenated diblock copolymer having an A′B′ structure or (A′B′)ₙZ structure with n=1, wherein A′=polyvinylaromatic, B′=ethylene and butylene or ethylene and propylene, Z=derivative of a coupling substance, or A′=A and B′=B,
b) a tackifier resin component,
c) optionally a plasticizer component,
d) at least 2.5% by weight to 22% by weight, of a reinforcing component which is at least one resin having an MMAP value between −10° C. and +30° C., and a softening point of at least 140° C.,
e) optionally further adjuvants,
the fraction of the elastomer component being based on the total weight of the pressure-sensitive adhesive compound,
and, the composition of the adhesive compounds on both sides is identical.

18. The self-adhesive product of claim 17, redetachable by extensive stretching wherein the self-adhesive product consists of
a single-layer permanent carrier, is composed of polyurethane.

19. An adhesively bonded assembly comprising at least one self-adhesive product of claim 13 and at least one substrate which is in contact with at least one layer of a pressure-sensitive adhesive compound, containing:
a) at least 28% by weight and at most 60% by weight of an elastomer component, wherein
i. the elastomer component contains at least 60% by weight based in each case on the elastomer component, of at least one hydrogenated polyvinylaromatic-polydiene block copolymer having a polyvinylaromatic fraction of at least 18% by weight and a peak molecular weight of 100,000 to 500,000 g/mol, determined according to GPC (Test I),
ii. the polydiene blocks are substantially fully hydrogenated,
iii. the hydrogenated polyvinylaromatic-polydiene block copolymer has an ABA structure, (AB)ₙZ structure with n=2 or radial (AB)ₙZ structure or radial (AB)ₙ−Z structure with n≥3, wherein A=polyvinylaromatic, B=ethylene and butylene or ethylene and propylene and Z=derivative of a coupling substance, and
iv. the elastomer component contains at least one kind of a hydrogenated diblock copolymer having an A′B′ structure or (A′B′)ₙZ structure with n=1, wherein A′=polyvinylaromatic, B′=ethylene and butylene or ethylene and propylene, Z=derivative of a coupling substance, or A′=A and B′=B,
b) a tackifier resin component,
c) optionally a plasticizer component,
d) at least 2.5% by weight to 22% by weight, of a reinforcing component which is at least one resin having an MMAP value between −10° C. and +30° C., and a softening point of at least 140° C.,
e) optionally further adjuvants,
the fraction of the elastomer component being based on the total weight of the pressure-sensitive adhesive compound.

20. The self-adhesive product according to claim 15, wherein the extensible permanent carrier material is a stretchable film which is made of at least one material selected from the group consisting of: polyolefins, such as ethylene, propylene, butylene and/or hexylene, polyurethanes, polyesterpolyurethanes, polyetherpolyurethanes, polycaprolactonepolyurethanes, ethylene-vinyl acetate (EVA) copolymers and rubber-based materials.
